(19) United States
(12) Patent Application Publication
(10) Pub. No.: US 2003/0218598 A1
(43) Pub. Date: Nov. 27, 2003

(54) Keyboard track stick

(76) Inventor: Naohiko Shibata, Fujisawa-Shi (JP)

Correspondence Address: SCHULTE ROTH & ZABEL LLP, ATTN: JOEL E. LUTZKER, 919 THIRD AVENUE, NEW YORK, NY, 10022, US

(21) Appl. No.: 10/401,080

(22) Filed: Mar. 27, 2003

(30) Foreign Application Priority Data
Mar. 29, 2002 (JP) 2002-094719

(51) Int. Cl. G09G 5/08

(52) U.S. Cl. 345/161

(57) ABSTRACT

A track stick for a keyboard having a base plate affixed to the keyboard frame and a flexible substrate disposed on the base plate. A flat sensor substrate having an upper surface, a side surface and an undersurface is disposed on the flexible substrate forming a gap there between. A member stick extends from the flat sensor substrate. Multiple strain sensors are symmetrically arrayed around an axial line of the stick member on the undersurface of the flat sensor substrate. Multiple electrodes are symmetrically disposed on the flexible substrate arrayed about an axial line of the sensor stick. Multiple “c”-shaped solder connection electrode terminals are placed on the undersurface of the flat sensor substrate and extend to the side surface of the flat sensor substrate and the electrode terminals are folded back to an upper surface of the flat sensor, wherein the electrode terminals are connected to each of the strain sensors and face each of the electrode terminals on the flexible substrate and in the gap.

### CROSS-REFERENCE TO RELATED APPLICATIONS

This application claims all rights of priority to Japanese Patent Application No. 2002-094719 filed on Mar. 29, 2002, (pending).

### BACKGROUND

This invention relates to a computer input device that enables a user to position a marker on the screen of a computer display device.

### PRIOR ART

A track stick is usually formed as a small button embedded between the “G,” “H” and “B” keys of a computer keyboard as a small stick which projects vertically from the keyboard. A number of strain-gauge sensors are arrayed around the base to detect force applied to the top of the stick. The strain gauges respond to forces, with no or only small actual motions of the stick. As a result, track sticks are particularly well suited for portable notebook computers, in which small size, and the ability to use the pointing device with only a small space available, for example, on an airplane tray table, are important. Typical types are “track stick,” “TrackPoint,” “AccuPoint,” “pointing stick” or “stick pointer.”

As shown in FIGS. 6(a) and (b), conventional track sticks 30 comprise flexible substrate 31 having a strain sensor glued inside a plastic pointing stick frame 32. The frame is heat-fused to a printed circuit board 34, while at the same time the flexible substrate 30 is soldered to the printed board connecting terminals 35 to circuit terminals 36. The printed circuit board 34 to which the pointing stick 30 is affixed is screwed onto the base plate 38, which is attached to the keyboard.

For this reason, the upper portion of the pointing stick is at a position that is higher by at least 1-2 mm than the keys on the keyboard. However, a specified length is also required from the standpoint of pointing stick functionality in the stick portion. At the same time, with portable computers such as notebook personal computers, it is desirable that the thickness of the main unit be made as thin as possible. Therefore, keyboard keys are becoming progressively thinner. Accordingly, lowering the height position of track stick is a pressing issue.

Previous track sticks have adopted a method whereby instead of heat-fusing the plastic frame to the printed board, an electrode 40 for solder connection is provided on the underside of the pointing stick 30 as seen in FIG. 7(a) (before assembly) and FIG. 7(b) (after assembly). The space between the electrode 60 and the solder connection electrode 42 on the epoxy substrate 34 serving as back plate is soldered. Attachment of the frame side of the pointing stick 30, to which the flexible substrate 31 with strain sensors is glued, and of the side on which the printed board 34 serves as a base plate can be accomplished by soldering between the electrodes 40 and 42. This simplifies the part mounting process. However, there has been a drawback in that the quality of the soldered electrode joint area could not be externally verified.

### BRIEF SUMMARY

An object of the present invention is to provide a track stick electrode structure that can implement a track stick thin-form structure. Another object is to provide a track stick that is easy to assemble with simple checking of solder connections in the electrode area.

The track stick of the present invention comprises a column vertically erected on a flat sensor substrate. Multiple strain sensors are symmetrically arrayed around the axial line of the column on the back side of the sensor substrate. A base plate is affixed to a keyboard frame and a flexible substrate, having multiple electrodes symmetrically arrayed around the axial line of the column, is affixed to the base plate. Multiple solder connection electrode terminals are disposed on the underside of the sensor substrate connected to each of the strain sensors and facing each of the flexible substrate electrodes.

The strain sensors are arrayed on the underside of the flat sensor substrate. The column and base plate are arranged along sides of the flexible substrate being separated by only a very small gap. Therefore, the total height of the track stick is essentially determined by the height of the stick. This is accomplished because the strain sensor is not arrayed on the stick side surface, but rather on the undersurface of the sensor substrate, thus enabling the dimension of the stick itself to be shortened.

Furthermore, the pointing stick of the present invention is distanced only by a very small gap from the base plate, which is joined directly to the keyboard frame. The flexible substrate electrodes and sensor substrate electrodes are soldered, so that force applied to the sensor stick will not cause damage or breakage of the constituent parts even with a relatively large overload. A touch track stick capable of withstanding this force can therefore be provided.

Also, because the force applied to the sensor stick is transmitted from the sensor substrate to the base plate, an accurate force acts on the strain sensor. As a result, no large calibration or compensation is required, and a track stick with an appropriate sensitivity and high reliability is provided.

Four of the strain sensors may be symmetrically arrayed at 90° spacing on the undersurface of the sensor substrate. The solder connection electrode terminals are arrayed to oppose one another on the outer side of the strain sensor. Since the sensor substrate is supported by the electrodes in a four-point support structure, the tilting motion of the column can be accurately transmitted to the strain sensor.

A track stick is having “c”-shaped electrodes extending to the side surface of the sensor substrate and fold back to the top surface thereof. This enables easy external quality verification of the solder fillets exposed on the side surface of the sensor substrate by soldering between the electrodes, and simplifying inspection of the solder condition. A flexible substrate is attached to a keyboard base plate. Strain sensors are arrayed on the underside of the sensor stick, specifically to the underside of the sensor substrate, thus allowing for the reduction of height of the stick. Furthermore, there is a very small gap between the base plate and the sensor stick where a flexible substrate is sandwiched. Therefore the overall pointing stick height can be reduced.

Since electrode terminals are disposed at both sides of each corner of the sensor substrate, forces acting on the column are reliably transmitted to the strain sensors due to the strong attachment that results from the four-point electrode support structure and the support obtained from side surfaces on both sides of the sensor substrate. This provides an improvement in track stick response and reliability.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is an exploded view of a track stick;

FIG. 2 is a side view of the track stick of FIG. 1;

FIG. 3(a) is a plan view of the stick portion of the track stick of FIG. 1;

FIG. 3(b) is a bottom plan view of the stick portion of the track stick of FIG. 1;

FIG. 4 is a plan view of electrodes on a flexible substrate attached to a base plate in the track stick of FIG. 1;

FIG. 5 is a side sectional view of the track stick of FIG. 1;

FIGS. 6(a) and 6(b) are prior art track stick devices; and

FIGS. 7(a) and 7(b) are side views of another prior art device.

### DETAILED DESCRIPTION

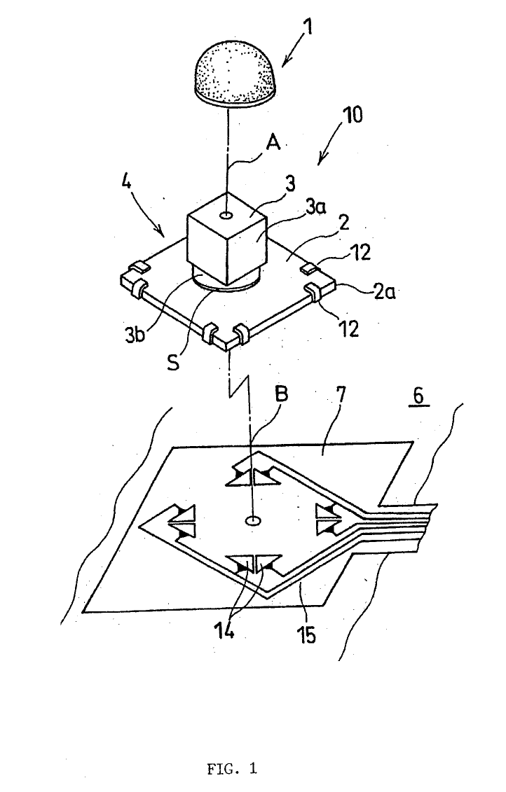

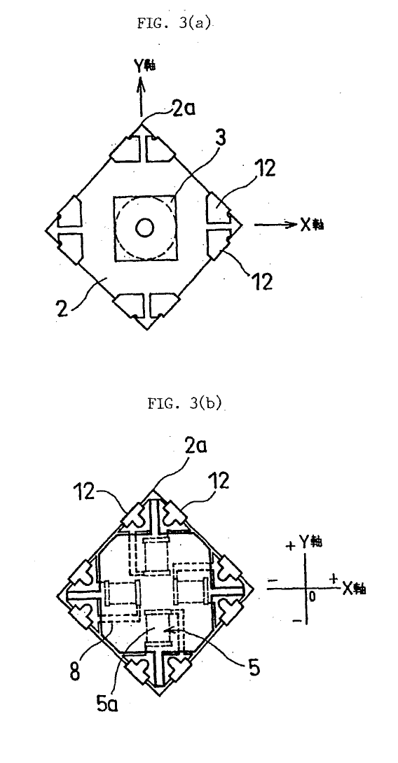

Referring to FIG. 1, track stick 10 includes rubber cap 1, rigid column 3 and slightly flexible sensor substrate 2 with strain sensors 5 (shown in FIG. 3(b)) bonded to the bottom of sensor substrate 2. As a user exerts or force on cap 1, the force slightly deforms sensor substrate 2, and strain gauges 5 modulate an electrical signal in a manner that represents the amount of force applied to cap 1. A pair of electrical contacts 12 are provided on each corner of sensor substrate 2. Each pair of electrical contacts 12 is soldered to a corresponding pair of contacts 14 to connect strain gauges 5 to electrical contacts 14.

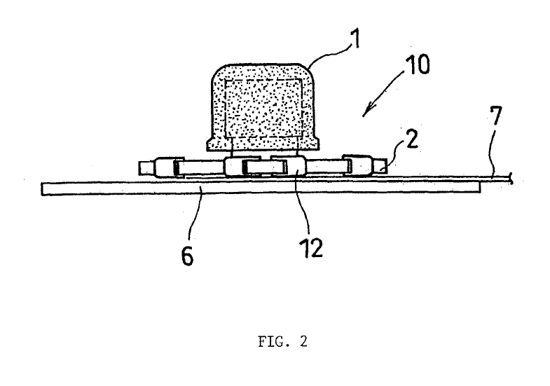

Referring to FIG. 2, track stick 10 includes rubber cap 1, a sensor stick 4 having column 3 vertically disposed on a flat sensor substrate 2. A strain sensor 5 (shown in FIG. 3(b)) is bonded to the undersurface of sensor substrate 2. Flexible substrate 7 is disposed on top of the base plate. Cap 1 fits onto column 3, forming the pointer stick being vertically disposed with respect to sensor substrate 2.

Sensor stick 4 comprises a square sensor substrate 2 and a column body 3. Column body 3 has a hole throughout its center. In this example of sensor stick 4, a lower cylindrical piece 3b of column 3 is inserted into the center opening of sensor substrate 2 and affixed by adhesive S. This sensor substrate 2 and column 3 generally comprise ceramic material, however, other materials with high heat resistance and insulating performance (for example, glass, synthetic resin, hollow metal, glass epoxy, etc.) may also be used. Also, sensor substrate 2 and column 3 may be formed in an integral structure. A screw fastener or other joining method may also be used in addition to the adhesive to join sensor substrate 2, column 3 and the flexible substrate. Therefore, positional error of the flexible substrate on the base plate is avoided. Since the flexible substrate is thinner and has a more accurate detection output with respect to strain degree, the device is thus capable of accurate and reliable operation.

Referring to FIGS. 3(a) and 3(b), it can be seen that sensor substrate 2 is a square, flat substrate. A connection electrode terminal 12 is provided at each side of each corner 2a, for a total of eight such electrode terminals 12. Electrode terminals 12 have a “c”-shape and are disposed around sensor substrate 2, extending from the undersurface of sensor substrate 2 to side surface 2a and folding back onto the upper surface. A thick film strain sensor 5 is bonded to the undersurface of sensor substrate 2.

Solder connection electrode terminals may be provided at both sides of each corner of the square sensor substrate and the flexible substrate electrodes are arranged such that left-right pairs of electrodes are respectively positioned with a 90° spacing, facing each of the soldering connection electrode terminals. The sensor substrate therefore achieves a four-point electrode support structure by soldering a total of eight electrodes, while at the same time a very strong attachment results from the support received from both sides of the sensor substrate. Therefore, the acting force is accurately transmitted from the strain sensor, and responsiveness and reliability with respect to the track stick tilting action is improved.

The solder connection electrode terminals are “c”-shaped electrodes that extend to the side surface of the sensor substrate and are folded back to the upper surface side thereof. Electrode terminals and electrodes on the flexible substrate are affixed by soldering, and are formed in the gap between the flexible substrate and the sensor substrate.

In other embodiments, sensor substrate 2 may be circular or other shapes, preferably polygonal. The number of electrode terminals may vary with the shape of sensor substrate 2, and/or with the number and positioning of the strain sensors 5.

In FIG. 3(b), strain sensors 5 are symmetrically arrayed, centered on axial line A of sensor stick 4. For example, four thick film resistors 5a are arrayed at a 90° spacing. Strain sensors 5 may be covered with an insulating film. Each thick film resistor 5a may be connected by conductors 8 to a pair of electrode terminals 12 attached to two sides of the corners 2a on the undersurface of sensor substrate 2.

When considering an X and Y axis coordinate system with the center of sensor substrate 2 as the 0 (origin) point (when viewed from above the stick), strain sensors 5 are arrayed in the following order, respectively: +X side on the X coordinate axis, +Y side on the Y coordinate axis, −X side on the X coordinate axis, and −Y side on the Y coordinate axis. Each strain sensor 5 is formed to have an axially symmetrical shape and thickness with respect to the arrayed X coordinate or Y coordinate axis, and is capable of compensating for strain that is symmetrically generated around the coordinate axis.

Thick film resistors 5a are formed by using a film deposition method such as vacuum deposition, sputtering, gas phase growth, etc. to deposit an electrically resistive material on sensor substrate 2. These strain sensors 5 comprise thick film resistors 5a, and therefore variability in characteristics is kept to a minimum, and strain detection can be effected at a high degree of strain detection accuracy. Strain sensors 5 may also be formed with printing technology using electrically conductive ink, or with photographic plate making technology such as photolithography or etching, etc.

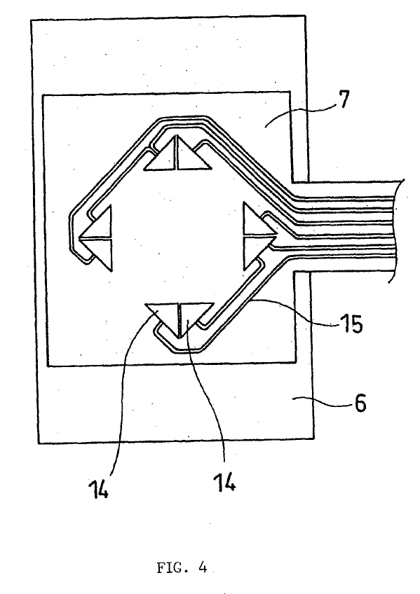

Referring to FIGS. 1 and 4, flexible substrate 7 is formed of a thin film and is affixed to base plate 6. Four pairs of electrodes 14 are arrayed on the film at a 90° spacing with respect to one another in positions symmetrical around the center line B, which conforms to the axial line A of sensor stick 4. Lead lines 15 extend from each of electrodes 14. When each of the substrate side electrode terminals 12 connect to thick film resistors 5a and are soldered together with each of the flexible substrate side electrodes 14, the four thick film resistors 5a are connected in bridge circuit, and form a circuit able to obtain a detection output from the strain sensors 5, corresponding to the track stick tilting action.

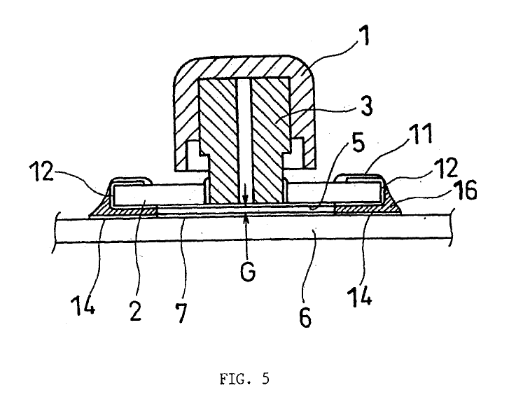

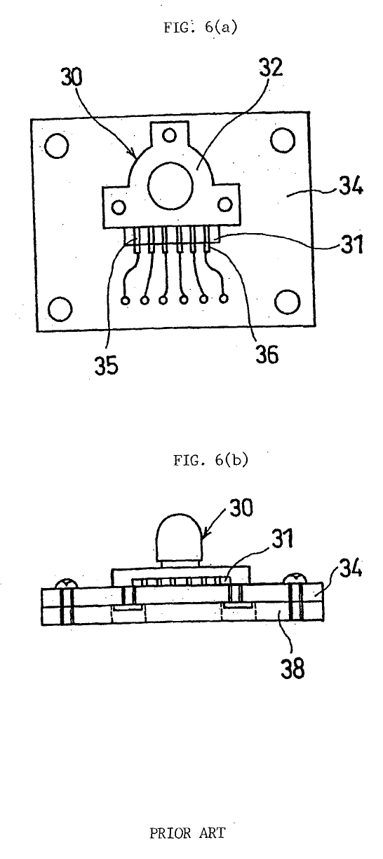

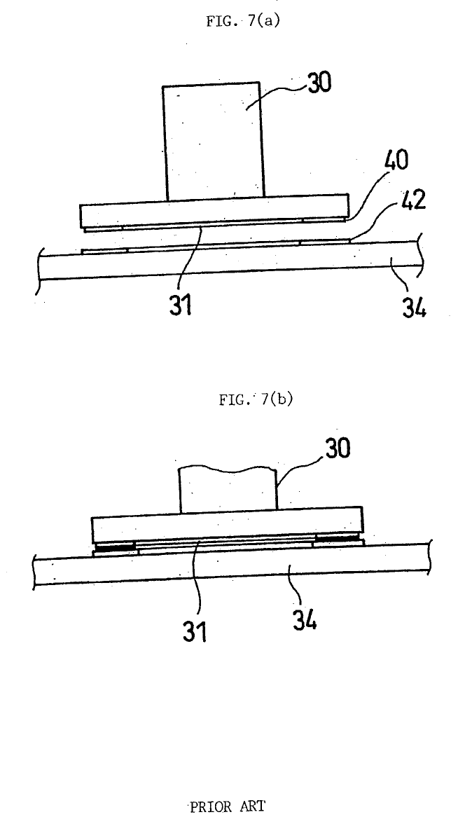

Referring to FIG. 5, electrode terminals 12 are attached to sensor substrate 2. Solder fillet 16 is formed on the corner side surface of electrode terminal 12. Electrode terminal 12 may, for example, be soldered between flexible substrate electrodes by forming a through-hole at the corner of the sensor substrate 2 and erecting an electrode terminal that inserts a pin or eyelet into this hole. However, compared to using electrode terminal 12, this method results in increased costs in the sensor substrate manufacturing process, and it is not possible to form a solder fillet on the side surface of the sensor substrate.

Electrode terminals 12 affixed to the sensor substrate 2 comprise “c”-shaped electrodes, and are respectively disposed on both sides of each corner on the sensor substrate 2. At the same time, four pairs of the flexible substrate electrodes 14 are arrayed at 90° spacing, and therefore the electrodes on the sensor substrate 2 and flexible substrate 7 are arrayed to oppose one another.

Each of the pairs of electrode terminals 12 and pairs of electrodes 14 on the flexible substrate is assembled by passing through a reflow furnace on an assembly line. One of the methods which can be utilized is the method whereby each electrode is coated with solder ahead of time and soldering is effected by heating in a reflow furnace. Alternatively, the flow solder method may be used whereby heated and melted liquid solder is supplied to the points of connection on the electrode. The surface of the electrode terminal 12 on the top side of sensor substrate 2 is protected by an insulating coating film 11.

Referring still to FIG. 5, strain sensors 5 are arrayed on the underside of sensor stick 4. By virtue of the soldering operation between electrodes 12 and 14, sensor substrate 2 rests just above flexible substrate 7 distanced by just the plate thickness of the electrode terminal 12 attached to the sensor substrate 2, and a gap G of approximately 0.1 to 0.5 mm. Gap G enables tilting of the sensor stick 4, and enables strain action on sensor substrate 2 centered on sensor stick 4.

The overall height of the track stick 10 is determined by the stick height. Because a flexible substrate is used in place of a printed board, it is possible to reduce what is normally a printed board thickness of greater than 1 mm to approximately 70 microns.

Signal processing circuit components comprising amplifiers, etc. (not shown) are mounted on the base plate. These signal processing circuits amplify the signal output from the thick film resistor bridge circuit that serves as strain sensor 5, and are capable of outputting the signal as a strain degree detection signal externally from the sensor substrate 2.

In sensor substrate 2, soldering of a total of eight electrodes allows the attachment and support of each corner respectively with pairs of electrodes, so that a four-point support structure for sensor stick 4 is formed, making for a strong attachment from both side surfaces of the corners of sensor substrate 2. As a result, the force operating on column 3 is reliably conveyed to strain sensors 5, and the response and reliability of track stick 10 are improved.

In track stick 10, sensor substrate 2 is affixed over base plate 6, which is directly affixed to the keyboard frame by soldering between the electrodes, leaving only a very small gap. Therefore, no damage or breakage occurs to the constituent parts even if the force exerted on column 3 is a relatively large overload. The track stick is strong and able to withstand the overload. Furthermore, because the force applied to the sensor stick is transmitted from the sensor board to the base plate, an accurate force acts on the strain sensor, such that no major calibration or compensation is required. This provides for a highly reliable track stick with accurate sensitivity.

Since the strain sensor is a thick film resistor formed on the underside of the sensor substrate, and the flexible substrate is bonded to the base plate, positional error of the flexible substrate on the base plate is reduced. Furthermore, the resistor formed of thick film is able to operate reliably due to its thinness and its accurate detection output with respect to degree of strain.

Track stick 10 is placed between the keys indicating “G”, “H” and “B” on the keyboard. Column 3 is disposed to be pushable forward and backward and left and right. When sensor substrate 2 is displaced according to the degree and direction of operation of column 3, the movement direction and speed of an arrow-shaped pointer shown on a display are obtained based on the detection signal from thick film resistors 5a, which detect the degree of displacement of sensor substrate 2, and processing is implemented to move the pointer using this motion data.

In the track stick, when an operator operates the stick, for example, to apply force toward the +side in the X coordinate axial direction and the Y coordinate axial direction, the sensor substrate deflects in response to the direction and degree of operation of the stick by bending. This deflection causes an increase in resistance value by generating a tensile stress on one of the strain sensors that exists on the +side of the X coordinate axis, while also causing a reduction in resistance value by generating a compression strain on another strain sensor that exists on the side of the X coordinate axis. The output signals from the X axis output terminal and Y axis output terminal thus change, and this output signal is then amplified and given as the degree of strain detection signal. Determination of the pointer movement direction and speed is accomplished by reading this signal into the CPU that executes the pointing control program.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

The invention claimed is:

1. A track stick for a keyboard comprising:
a base plate affixed to the keyboard frame;
a flexible substrate disposed on said base plate;
a flat sensor substrate having an upper surface, a side surface and an undersurface being disposed on said flexible substrate forming a gap there between;
a stick member extending from said flat sensor substrate;
multiple strain sensors symmetrically arrayed around an axial line of said stick member on said undersurface of said flat sensor substrate; and
multiple electrodes symmetrically disposed on said flexible substrate arrayed about an axial line of said sensor stick.

2. The track stick according to claim 1, wherein multiple “c”-shaped solder connection electrode terminals placed on said undersurface of said flat sensor substrate.

3. The track stick according to claim 1, wherein said multiple “c” shaped solder connection electrode terminals placed on undersurface of said flat sensor substrate extend to said side surface of said flat sensor substrate and said electrode terminals are folded back to an upper surface of said flat sensor, wherein said electrode terminals are connected to each of said strain sensors and face each of said electrode terminals on said flexible substrate.

4. The track stick according to claim 1, wherein said strain sensors are symmetrically arrayed at 90° spacing with respect to one another.

5. The track stick according to claim 1, wherein said solder connection electrode terminals are arrayed to face an outer side of said strain sensor.

6. The track stick according to claim 1, wherein said solder connection electrode terminals are disposed on both sides of each corner of said flat sensor substrate.

7. The track stick according to claim 1, wherein said flexible substrate electrodes are arrayed at 90° spacing.

8. The track stick according to claim 1, wherein said strain sensors comprise thick film resistors formed on said undersurface of said sensor substrate and said flexible substrate is bonded to said base plate.

9. The track stick according to claim 1, wherein said gap is formed from the thickness of the solder connection electrode terminals and is in the range of approximately 0.1-0.5 mm.

10. A keyboard having a track stick, said track stick comprising:
a base plate affixed to the keyboard frame;
a flexible substrate disposed on said base plate;
a flat sensor substrate having an upper surface, a side surface and an undersurface being disposed on said flexible substrate forming a gap there between;
a stick member extending from said flat sensor substrate;
multiple strain sensors symmetrically arrayed around an axial line of said stick member on said undersurface of said flat sensor substrate; and
multiple electrodes symmetrically disposed on said flexible substrate arrayed about an axial line of said sensor stick.
